(19) United States
(12) Patent Application Publication
(10) Pub. No.: US 2023/0304561 A1
(43) Pub. Date: Sep. 28, 2023

(54) SWITCHABLE HYDRO MOUNT

(71) Applicant: Vibracoustic SE, Darmstadt (DE)

(72) Inventors: Wolfgang Beckmann, Darmstadt (DE); Roland Holz, Fuerth (DE); Stefan Gölz, Weinheim (DE); Bernhard Röhrig, Heppenheim (DE)

(21) Appl. No.: 18/018,292

(22) PCT Filed: Apr. 14, 2021
(86) PCT No.: PCT/EP2021/059713

§ 371 Date: Jan. 27, 2023

(30) Foreign Application Priority Data
Jul. 30, 2020 (DE) 10 2020 120 176.1

(51) Int. Cl. F16F 13/10; F16F 13/26

(52) U.S. Cl. CPC F16F 13/106; F16F 13/262

(57) ABSTRACT

A switchable hydraulic bearing for mounting of a motor-vehicle assembly comprises a support bearing and a mount connected by a support spring, and a working chamber and an equalization chamber fillable with damping liquid that are spatially separated by a separating wall and connected by a damping channel in the separating wall. The separating wall may comprise a nozzle cage with two adjacent nozzle discs provided with an axial spacing. A diaphragm of rubber-elastic material may be provided in a gap between the nozzle discs. The diaphragm may be switchable by a switching device comprising an elastic lever disc axially adjacent to the second nozzle disc. An electromagnet may connect to the lever disc and can adjust the lever disc between a first position, permitting axial play of the diaphragm in the gap, and a second position, acting on the second nozzle disc and clamping the diaphragm between nozzle discs.

### CROSS-REFERENCE TO RELATED APPLICATIONS

This application is a National Stage Patent Application of International Patent Application No. PCT/EP2021/059713, filed Apr. 14, 2021, which claims the benefit of German Application Serial No. 10 2020 120 176.1, filed Jul. 30, 2020, the contents of each are incorporated by reference in their entireties.

### TECHNICAL FIELD

The invention relates to a switchable hydraulic bearings and mounts, including switchable hydraulic bearings that are as suitable for hydro mounts and motor vehicle assembly.

### BACKGROUND

A bearing of said type is known for example from EP 2711585 B 1. In this case, use is made of negative pressure for switching, this requiring however a pneumatic system, which results in an elaborate construction. Moreover, a considerable force has to be applied for switching of the hydraulic bearing.

The present disclosure is therefore based on addressing challenges or limitations with known bearings and providing a switchable hydraulic bearing which may be of simpler construction and/or less expensive to produce, and/or may be switchable with little applied force.

Aspects and features of embodiments of the invention are disclosed herein.

### SUMMARY

According to embodiments, a switchable hydraulic bearing is disclosed that may serve for mounting of a motor-vehicle assembly, and may comprise a support bearing and a mount, which are connected to one another by a support spring, and a working chamber and an equalization chamber, which are able to be filled with damping liquid and, at their sides facing axially towards one another, are spatially separated from one another by a separating wall and are connected to one another in a liquid-conducting manner by a damping channel arranged in the separating wall, wherein the separating wall is in the form of a nozzle cage with two nozzle discs which are arranged adjacent to one another with an axial spacing, wherein a diaphragm composed of a rubber-elastic material is arranged in the gap formed by the axial spacing between the nozzle discs, and wherein the mobility of the diaphragm is switchable by a switching device. The switching device comprises an elastic lever disc, which is arranged axially adjacent to the second nozzle disc and so as to be able to act thereon, and an electromagnet, which is connected to the lever disc and can adjust the lever disc optionally between a first position, in which the lever disc permits axial play of the diaphragm in the gap, and a second position, in which the lever disc acts on the second nozzle disc and clamps the diaphragm between the nozzle discs.

Embodiments of the disclosure may make use of an electromagnet to achieve an adjustment of the diaphragm or a switchover of the hydraulic bearing in a simple manner by way of switching. As a result of an electromagnet being used, there is no need for a pneumatic system and, moreover, for the provision of connections for air-pressure lines, which considerably reduces the complexity of housing parts or of the mount.

The electromagnet may be connected to the lever disc in an indirectly or directly mechanically interacting manner. Via the lever disc, the electromagnet transmits the actuation movement, which is preferably axial, to the second nozzle disc and in this way acts thereon. The second nozzle disc is consequently adjusted axially from the first position into the second position. Action of said type is not realized in the first position. In the first position, the diaphragm is not clamped by way of action of the nozzle disc. Although the lever disc can abut against the second nozzle disc, it is conceivable that it exerts no or only a small adjusting force thereon, and preferably only abuts thereon. It is also conceivable that, in the first position, the electromagnet does not act on the lever disc, that is to say exert on the lever disc a force adjusting the lever disc. The second nozzle disc may be preloaded into a position in which the gap is opened to the greatest possible extent or in which the second nozzle disc occupies a gap-enlarging position. Action by means of the lever disc may therefore be realized counter to a preload force acting on the second nozzle disc. It is conceivable that the first nozzle disc is positionally fixed and therefore not axially adjustable. The second nozzle disc is, as a result of the action, also adjustable relative to the first nozzle disc, wherein the two nozzle discs are spaced axially apart to a greater extent in the first position than in the second position. It is conceivable for the first position to be realized in the electrically deenergized state of the electromagnet and for electrical energization to result in the formation of the second position. According to embodiments of the invention, switching of the electromagnet now influences the amount of axial play of the diaphragm in the gap between the two nozzle discs. The amount of axial play may lie in the range of 0.1 mm to 0.5 mm, and is preferably 0.2 mm.

The diaphragm, which consists of a rubber-elastic material, is arranged between the two nozzle discs for isolation purposes. There, it is able to be impinged upon, and is able to be deformed in an elastically compliant manner, by damping liquid from the working chamber and the equalization chamber. The diaphragm serves for isolation of small-amplitude, high-frequency vibrations. Vibrations of said type are generated for example from the gas and inertia forces of the engine. In this case, frequencies of approximately 50 Hz to 100 Hz and amplitudes of approximately less than 0.1 mm are involved.

Depending on the design of the hydraulic bearing, it is possible for example by application or removal of an electric current at the electromagnet for the second nozzle disc to be adjusted in the direction of the first nozzle disc, in order in this way to reduce the size of the gap axially and consequently to at least reduce, or even to eliminate, the axial play or the vibration capability of the diaphragm. The axial spacing of the nozzle discs in relation to one another is therefore variable. The axial mobility of the diaphragm can consequently be limited or even eliminated. It is also possible for the diaphragm, in said second position of the lever disc, to abut against at least one of the nozzle discs, preferably against both nozzle discs, such that the diaphragm is inactive. In this way, the damping in the high-frequency range can be deactivated. To activate the diaphragm, the supply of current to the electromagnet is correspondingly either applied or interrupted. It is accordingly possible for the strength of the hydraulic bearing to be influenced by means of the diaphragm.

The lever disc may be attached centrally to the electromagnet and utilizes the mechanical lever. In this way, said lever disc serves for reduction of the force to be applied for switching purposes. The actuation force of the electromagnet is transmitted via the lever disc, which makes possible the use of a small, light and inexpensive electromagnet. The lever disc may at least intermittently abut against a point of rotation and/or at least sectionally form or comprise a lever, preferably a two-sided lever. The point of rotation is understandable physically and not geometrically. The lever disc can rotate via a point or a line segment.

According to one refinement, the switchable hydraulic bearing according to embodiments of the invention may be configured in such a way that the nozzle cage forms at least one point of rotation against which the lever disc, during adjustment between its two positions, is supported in a lever-arm-forming manner. This makes possible a compact design of the hydraulic bearing, since the point of rotation is arranged in the spatial vicinity of the nozzle disc to be adjusted. The point of rotation may be formed for example on a projection, an edge or on a surface.

According to one refinement of the hydraulic bearing, the nozzle cage may have a channel ring which is arranged axially and/or radially adjacent to the second nozzle disc, said channel ring preferably having at least one radially running lever tongue on which the at least one point of rotation is formed. The channel ring may form the at least one point of rotation. Preferably, the channel ring has multiple lever tongues, more preferably three lever tongues. Preferably, the lever tongues are arranged spaced uniformly apart from one another, for example offset by 120° in relation to a central longitudinal axis that passes through the hydraulic bearing. The channel ring may be mounted in a positionally fixed manner, for example to a bearing cover. A rolling bellows or a rolling-bellows-like closure diaphragm may be arranged on the bearing cover and/or on the channel ring. The rolling bellows may delimit the equalization chamber. Thus, the channel ring, the lever disc, the second nozzle disc, the diaphragm and the first nozzle disc may be arranged in this order and preferably coaxially in an axial direction along the central longitudinal axis. The at least one lever tongue may extend radially in the direction of the central longitudinal axis. The at least one lever tongue may be arranged offset from the second nozzle disc in an axial direction or longitudinal direction.

The channel ring may alternatively or additionally be arranged radially adjacent to the second nozzle disc. The channel ring may have a receiving cutout for receiving the second nozzle disc. In this case, the second nozzle disc may be arranged in the inner clearance of the channel ring. The second nozzle disc may be guided at the outer circumference, preferably exclusively at the outer circumference. It is advantageous that an inner circumferential surface of the nozzle disc may serve as a bearing, preferably a plain bearing, for the second nozzle disc, which may be in abutment there via its outer circumferential surface. In this way, the second nozzle disc can be guided in a simple and reliable manner and jamming can be prevented. Preferably, the second nozzle disc is free of a centrally arranged guide device, such as for example a central cutout or a central pin.

In the channel ring, there may be formed in the region of its outer circumference the damping channel or a portion of the damping channel. In the first nozzle disc, there may be formed in the region of its outer circumference the damping channel or a portion of the damping channel. It is conceivable for the channel ring and the first nozzle disc to delimit the damping channel. It is conceivable for at least one of those sides of the channel ring and the first nozzle disc which face towards one another to have a groove-shaped cutout, which preferably runs in a circumferential direction. Preferably, provision is made on both sides of one such cutout in each case, so that the channel ring forms a first axial portion and the first nozzle disc forms a second axial portion of the damping channel. The damping channel serves for damping low-frequency, large-amplitude vibrations.

A preferably elongate lever projection may be formed on the lever tongue, the lever projection preferably extending in a circumferential direction or in a tangential direction in relation to the central longitudinal axis. The lever projection may have at least one point or one line for rotation. The lever projection may be arranged on that side of the lever tongue which faces towards the second nozzle disc. The lever projection may extend over the entire width of the lever tongue, that is to say orthogonally to the radial direction, in order to ensure the widest or largest possible abutment surface.

The channel ring may have a receiving cutout for receiving the lever disc or parts of the lever disc. Preferably, the receiving cutout is arranged annularly and/or coaxially in relation to the central longitudinal axis and/or axially in relation to the second nozzle disc, preferably on the side facing towards the second nozzle disc. It is conceivable that the lever disc is in a state at least partially received in the receiving cutout in the position in which said lever disc permits axial play of the diaphragm in the gap. It is conceivable that the lever disc is in a state at least partially adjusted out of the receiving cutout in the position in which the lever disc acts on the second nozzle disc and clamps the diaphragm between the nozzle discs.

The at least one lever tongue is able to be substituted by for example a ring or a ring portion that projects radially inwards.

It is conceivable that the at least one lever tongue projects over the second nozzle disc in a radial direction. The at least one lever tongue is thus arranged adjacent to the second nozzle disc in an axial direction or longitudinal direction, whereby it is also the case that the channel ring is then, at least sectionally, arranged axially adjacent to the nozzle disc. As a result of this over-engaging arrangement of the at least one lever tongue, the lever disc may be arranged in an axial space between lever tongue and second nozzle disc in order, during adjustment, to be supported against the lever tongue and to act on the second nozzle disc. This embodiment serves for compactness of the hydraulic bearing since the nozzle cage can be made in a very flat form.

According to one refinement of the hydraulic bearing, the lever disc may have a circumferentially outer pressing ring and/or multiple, preferably three, radially running lever webs, each of which forms a lever arm. The lever webs may projects from the pressing ring radially and/or be arranged on a central portion, which is preferably passed through by the central longitudinal axis and/or is of cylindrical form. The lever webs may project from the central portion radially in a star-like manner. The lever webs may be mounted on the central portion in a floating manner and/or be arranged there by means of a form fit and/or force fit. The central portion may have a radially thickened head portion for engaging below the lever webs. This serves for transmission of the actuation movement of the electromagnet to the lever webs. The central portion may be part of the lever disc or part of a driver, which driver may be a separate element in relation to the lever disc.

The pressure ring may for example connect, preferably circumferentially, all the lever webs to one another in a circular manner and/or adjacent lever webs to one another in a circular-arc-shaped manner, and serves for uniform distribution of forces in the lever disc and into the second nozzle disc. Preferably, the lever tongues are arranged spaced uniformly apart from one another, for example offset by 120° in relation to a central longitudinal axis. Each lever web may be assigned to a lever tongue and be supported there in order to form the point of rotation. Consequently, each lever web may comprise a resistance arm and a force arm. That portion of the pressing ring which is at the outer circumference can be added to the resistance arm. The lever disc may be manufactured from a metal or a plastic material. The lever arms and the pressing ring may be formed in a materially uniform manner. The lever arms and/or the pressing ring may be formed so as to be able to abut against the second nozzle disc for adjustment thereof.

According to one refinement, it is conceivable that the length ratio of resistance arm to force arm of the lever arm is between 1:10 and 1:2, and preferably is 1:6. These ratios offer a best-possible balance between force of the electromagnet to be applied and required structural space, in particular in the region of the nozzle cage.

According to one refinement, the lever disc may have at least one retaining device which interacts with an retaining partner, wherein the retaining device may be an retaining cutout or an retaining pin and the retaining partner is the in each case other element of the retaining cutout and the retaining pin. The retaining partner may be arranged at the lever tongue such that, for this purpose, no further element for bearing the retaining partner is to be provided. The retaining cutout may be of oval or elongate form. Preferably, it extends in a radial direction in order to permit mobility of the lever web in a radial direction and/or to form a stop in order to limit an adjustment path in a radial direction. Each lever web may have an retaining cutout, the retaining cutouts preferably each being formed in the intermediate region of lever web and pressing ring.

According to a further configuration of the hydraulic bearing, the second nozzle disc may have a circumferential pressing edge which has a greater axial extent than the main body of the nozzle disc, and/or the lever disc may be arranged and/or formed in such a way that, in its second position, said lever disc acts on the pressing edge. The main body of the nozzle disc may be radially delimited by the pressing edge. As a result of the main body set back axially in relation to the pressing edge, the driver or the central portion or the thickened head portion may abut against the main body and/or the lever disc may be oriented in a position orthogonal to the central longitudinal axis. In this way, the required structural space can be kept small.

According to one refinement, in the hydraulic bearing, the electromagnet may be connected, preferably connected in a floating manner, to the lever disc via the driver. The fact that a fixed connection, such as for example a material bond or a press fit, between driver and lever disc has been dispensed with means that the lever action can be considerably improved and at the same time the structural space can be kept small. This is because, when lever arms are used, it is necessary, in the levering state, for these to bend only in one direction, specifically around the point of rotation. If, by contrast, the lever arms were connected fixedly to the driver at one side, this would lead to a second bending in the direction opposite to the bending causing the adjustment and at least partially eliminate it.

According to one refinement, in the hydraulic bearing, a spring element, preferably a clamping spring, more preferably a wave spring, may be arranged in the gap, said spring element being able to be supported against the two nozzle discs and being able to preload the second nozzle disc into a gap-enlarging position. In principle and more generally, however, any force-storing device or any spring element that can preload the second nozzle disc into a gap-enlarging position is conceivable. This may be realized by means of tension and/or pressure on the second nozzle disc. The force-storing device advantageously produces the play of the diaphragm.

Further features, details and advantages of the present disclosure emerge from the wording of the claims and from the following description of exemplary embodiments on the basis of the drawings. In the drawings:

### BRIEF DESCRIPTION OF THE DRAWINGS

FIG. 1 generally illustrates a longitudinal sectional view through an embodiment of a hydraulic bearing according to the disclosure,

FIG. 2a generally illustrates a perspective view of an embodiment of an assembled nozzle cage,

FIG. 2b generally illustrates an exploded view of the nozzle cage as per FIG. 2a,

FIG. 3 generally illustrates a detail view of the hydraulic bearing such as per FIG. 1 in a first position, and

FIG. 4 generally illustrates a detail view of the hydraulic bearing such as per FIG. 1 in a second position.

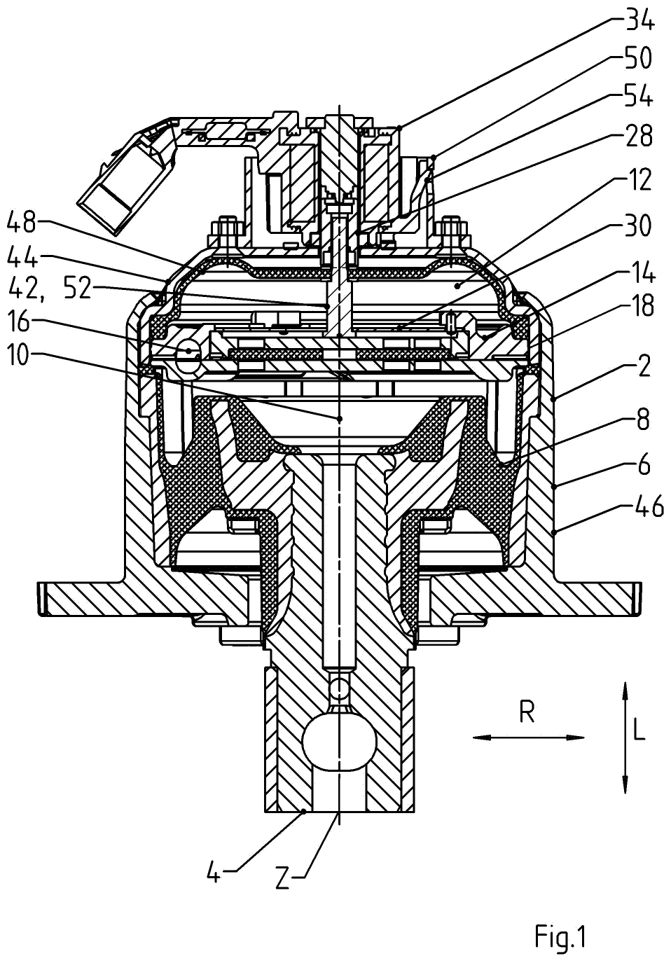

### DETAILED DESCRIPTION

In the figures, identical or mutually corresponding elements are denoted in each case by the same reference signs and will therefore not be described again unless expedient. In order to avoid repetitions, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions according to the present disclosure.

The hydraulic bearing 2 shown may serve as an engine bearing, and comprises a support bearing 4 and a mount 6 which are connected to one another by a support spring 8 composed of rubber-elastic material that is at least sectionally of hollow-conical form. A central longitudinal axis Z passes through the hydraulic bearing 2 in a longitudinal direction L. The support bearing 4 comprises the core of the hydraulic bearing 2, and the mount 6 comprises the housing of the hydraulic bearing 2, such as a bearing cover 44 and a bearing body 46. A working chamber 10 filled with the damping liquid is arranged within the hydraulic bearing 2, said working chamber being axially delimited at one side by the support bearing 4 and at the other side by a separating wall 14. An equalization chamber 12 is axially delimited at one side by the separating wall 14 and at the other side by a rolling bellows 48, wherein the rolling bellows 48 is elastically compliant in such a way that a volume of damping liquid displaced from the working chamber 10 passes into the equalization chamber 12 by way of a damping channel 16 formed in the separating wall 14 without the pressure in the equalization chamber 12 being significantly changed. The equalization chamber 12 may be formed so as to receive volumes in a substantially pressureless manner.

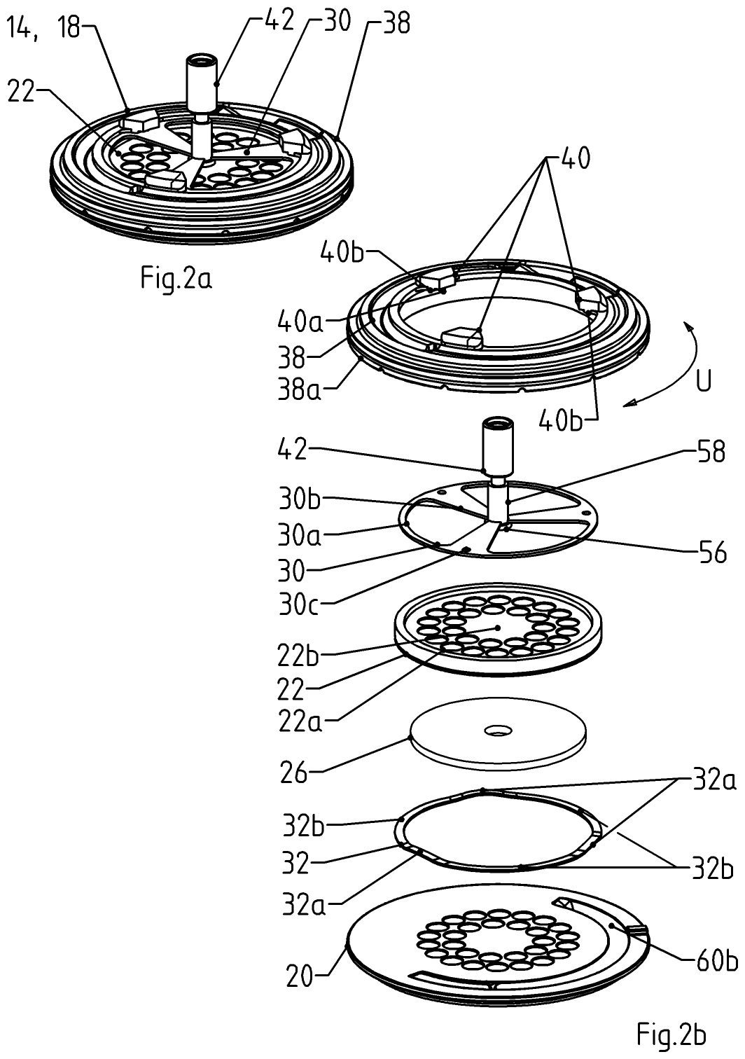

The separating wall 14 is in the form of a nozzle cage 18, which is shown explicitly in FIGS. 2a and 2b. The nozzle cage 18 comprises a first nozzle disc 20 and a second nozzle disc 22, which are arranged adjacent to one another with an axial spacing and form between them a gap 24. The nozzle discs 20, 22 comprise holes, which pass axially therethrough, in order to be able to be flowed through by damping liquid. In the gap 24, there are arranged a disc-shaped diaphragm 26 composed of a rubber-elastic material and a wave spring 32 acting as a force-storing device. The nozzle cage 18 furthermore comprises a channel ring 38 which is arranged adjacent to the second nozzle disc 22.

At its side facing towards the channel ring 38, the first nozzle disc 20 has a cutout, or semi-circular groove 60a, which runs in a circumferential direction U. Correspondingly, at its side facing towards the first nozzle disc 20, the channel ring 38 has a cutout, or semi-circular groove 60b, which runs in a circumferential direction U. The two grooves 60a and 60b each form an axial portion of the damping channel 16.

The wave spring 32 is formed so as to be closed in a circular manner, is of single-layer form and comprises three waves 32a, which are spaced uniformly apart, and base portions 32b arranged therebetween, which lie in a common transverse plane. The base portions 32b are supported against the first nozzle disc 20, and the waves 32a are supported against the second nozzle disc 22. The wave spring 32 preloads the axially movable second nozzle disc 22 in relation to the positionally fixed first nozzle disc 20 into a position in which the gap 24 is as large as possible. However, in principle differently arranged and/or formed force-storing devices for generating a preload are also conceivable. In the gap 24, the movement of the diaphragm 26 in a radial direction R is limited and guided by the second nozzle disc 22.

The second nozzle disc 22 comprises a pressing edge 22a and a main body 22b, wherein the pressing edge 22a radially delimits the main body 22b. The pressing edge 22a is thus arranged circumferentially. The lever disc 30 may be in abutment, and introduce the actuation force, at the pressing edge 22a. The second nozzle disc 22 moreover has a guide edge 22c at its oppositely situated side, said guide edge being arranged circumferentially in relation to the diaphragm 26 and serving for guiding the diaphragm 26. The guide edge 22c radially encloses a clearance 68 whose extent in a longitudinal direction L corresponds to the longitudinal extent of the diaphragm 26. The longitudinal extent of the guide edge 22c may be identical to the longitudinal extent of the diaphragm 26. This serves for clamping of the diaphragm 26.

The channel ring 38 is fastened in a positionally fixed manner to the bearing cover 44 and has a ring body 38a in which the groove 60b is formed. Proceeding from the ring body 38a, three lever tongues 40 spaced uniformly apart from one another along the circumferential direction U extend in a radial direction R towards the central longitudinal axis Z. The lever tongues 40 have a cross section which is approximately in the form of an isosceles trapezium and which tapers in the direction of the central longitudinal axis Z. The lever tongues 40 engage over the second nozzle disc 22 and are therefore arranged offset from the second nozzle disc 22 in an axial direction or longitudinal direction L. At their side facing towards the second nozzle disc 22, each lever tongue 40 comprises an retaining pin 40a and an elongate and/or wall-like lever projection 40b. Each lever projection 40b projects in a longitudinal direction L from the corresponding lever tongue 40 and extends in a tangential direction in relation to the central longitudinal axis Z. In this case, each lever projection 40b extends over the entire width of the respective lever tongue 40. A physical point of rotation 36 in the geometrical form of a line is able to be formed at each lever projection 40b. In principle, it is conceivable for the lever tongues 40, as viewed in a longitudinal direction L, to be arranged offset from the waves 32a of the wave spring 32, so that a small force is required for adjustment of the second nozzle disc 22 by means of an electromagnet 34. Preferably, the number of lever tongues 40 is equal to the number of waves 32a. Preferably, the channel ring 38 and/or the wave spring 32 are/is arranged and/or formed in such a way that each lever tongue 40, as viewed in a longitudinal direction L, is arranged centrally between two adjacent waves 32a.

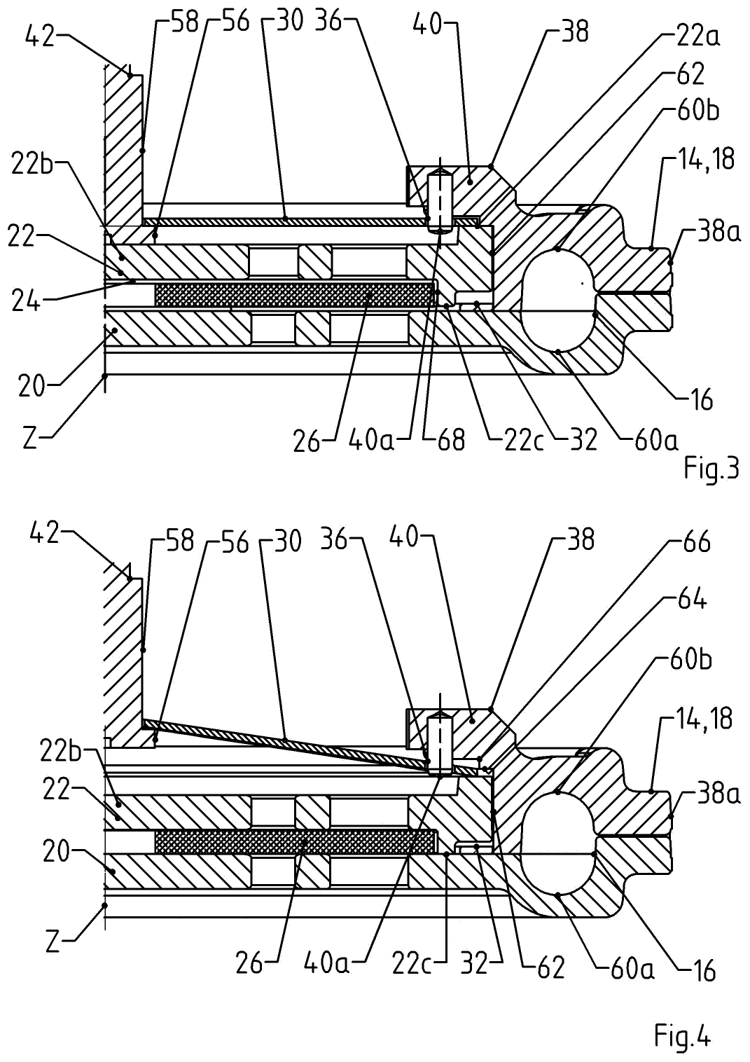

The channel ring 38 radially delimits, by way of its ring body 38a, a clearance 62 in which the second nozzle disc 22 is received, limited radially in terms of movement and axially guided. The lever tongues 40 form axial stops 64 which limit a movement of the second nozzle disc 22 in a longitudinal direction L, as shown in FIGS. 3 and 4. The channel ring 38 moreover has a step-like and annular receiving cutout 66 for receiving the lever disc 30, as likewise shown in FIGS. 3 and 4.

The lever disc 30 comprises a circumferentially outer pressing ring 30a and three lever webs 30b which are spaced uniformly apart from one another in a circumferential direction U. The pressing ring 30a connects the lever webs 30b circumferentially to one another and may abut against the pressing edge 22a of the second nozzle disc 22. Each lever web 30b forms a physical lever arm. The lever webs 30b project from the pressing ring 30a in a radial direction R and extend linearly towards the central longitudinal axis Z. They are thus arranged in a star-shaped manner about the central longitudinal axis Z. As FIGS. 3 and 4 show, at their side situated opposite the pressing ring 30a, the lever webs 30b abut in a floating manner on the thickened head portion 56, which thus engages below the lever webs 30b. The lever webs 30b and the lever tongues 40, as viewed in a longitudinal direction L, are arranged in a congruent manner. Each lever web 30b abuts against a lever projection 40b such that there is formed a force arm in the region arranged radially at the inside in relation to the lever projection 40b and a resistance arm in the region arranged radially at the outside in relation to the lever projection 40b. A two-sided lever is thus created. The length ratio of resistance arm to force arm is 1:6.

The lever disc 30 has an retaining cutout 30c in the intermediate or boundary region of each lever web 30b and the pressing ring 30a. Said retaining cutout may be through-going and/or of oval form and/or arranged so as to extend in a radial direction R. An retaining pin 40a engages into each retaining cutout 30c in order to prevent rotation of the lever disc 30 about the central longitudinal axis Z, but to permit mobility of the lever disc 30 or the lever webs 30b in a radial direction R. The radial extent of the retaining cutout 30c may be used to form stops and consequently to limit the radial movement of the lever webs 30b.

A switching device 28 serves for switching of the hydraulic bearing 2 by way of switching of the diaphragm mobility. The switching device 28 comprises an electromagnet 34 and a lever disc 30 that is arranged between the second nozzle disc 22 and the channel ring 38 in a longitudinal direction L. There, the lever disc 30 can act on the second nozzle disc 22. The switching device 28 accordingly engages into the nozzle cage 18. At one end, the hydraulic bearing 2 comprises the coil-comprising electromagnet 34 to which electric current can be applied, which may be designed as a monostable and closed single solenoid and which can perform an actuation movement in the direction of the central longitudinal axis Z. The electromagnet 34 is accommodated in a magnet housing 50, that is screwed to the bearing cover 44, or is clipped on there in a captive manner by means of a clip arrangement 54, wherein a plunger 52 of the electromagnet 34 projects through congruent cutouts in the bearing cover 44 and in the magnet housing 50. The plunger 52 may be in the form of a driver 42 or be connected fixedly thereto. At its end situated opposite the electromagnet 34, the driver 42 has a head portion 56 which is thickened radially in relation to its central portion 58.

The switching of the hydraulic bearing 2 will be described hereinbelow. The lever disc 30 is adjustable optionally between a first position (shown in FIG. 3), in which it permits axial play of the diaphragm 26 in the gap 24, and a second position (shown in FIG. 4), in which it acts on the second nozzle disc 22 and clamps the diaphragm 26 between the nozzle discs 20, 22.

In the electrically deenergized state of the electromagnet 34, the plunger 52 thereof is in an extended state and consequently also the driver 42 is in a state adjusted in the direction of the second nozzle disc 42. The thickened head portion 56 abuts against the second nozzle disc 22 or the main body 22b thereof. The lever disc 30 is in an unloaded state and runs orthogonally to the central longitudinal axis Z. Said lever disc abuts at one side against the channel ring 38, in the receiving cutout thereof 66, and at the other side against the pressing edge 22a of the second nozzle disc 22, without however exerting a force that adjusts the second nozzle disc 22 on the latter. Although it is conceivable that, in this first position too, owing to the construction, a small force is exerted on the second nozzle disc 22 by the lever disc 30, this force is smaller than the preload force exerted on the second nozzle disc 22 by means of the wave spring 32, so that an adjustment does not take place. In the first position, the gap 24 has its maximum longitudinal extent and the diaphragm 26 has a large amount of play. Consequently, the hydraulic bearing 2 is in a decoupled state and damping is improved.

If the electromagnet 34 or its coil, comprising a winding, is then electrically energized, its plunger 52, and therefore also the driver 42, is retracted into the electromagnet 34 or adjusted into it. This adjustment movement results in the head portion 56, which engages below the lever webs 30b, being adjusted upwards in the plane of the of drawing and lifting the lever webs 30b centrally. Since points of rotation 36 are formed, the load-arm portion of each lever web 30b and also the pressing ring 30a move downwards in the plane of the drawing. This movement is transmitted by the lever disc 30 to the second nozzle disc 22 and adjusts the latter counter to the spring force of the wave spring 32 downwards in the plane of the drawing, that is to say in the direction towards the first nozzle disc 20. In this way, the gap 24 is shortened in a longitudinal direction L until the second nozzle plate 22 comes into abutment against the first nozzle plate 20—the second position is realized. The minimum longitudinal extent of the gap 24 is determined by the longitudinal extent of the guide edge 22c, which is arranged on the second nozzle plate 22 in this embodiment, but may in principle also be arranged on the first nozzle plate 20. Since the minimum longitudinal extent of the gap 24 corresponds to the longitudinal extent of the diaphragm 26, the latter is then clamped, which considerably improves the driving dynamics.

If the electrical energization is then withdrawn, the lever disc 30 pulls the plunger 52 and the driver 42 in the direction of the second nozzle disc 22 and the second nozzle disc 22 is spaced apart from the first nozzle disc 20 again by means of the wave spring 32.

The invention is not restricted to one of the embodiments described above, but rather may be modified in a variety of ways. All the features and advantages that emerge from the claims, from the description and from the drawing, including structural details, spatial arrangements and method steps, may be essential to the invention both individually and in a wide variety of combinations.

The invention encompasses all combinations of at least two of the features disclosed in the description, the claims and/or the figures.

To avoid repetitions, it is the intention that features disclosed in device terms are also disclosed, and capable of being claimed, in method terms. It is likewise the intention that features disclosed in method terms are disclosed, and capable of being claimed, in device terms.

1. Switchable hydraulic bearing for mounting of a motor-vehicle assembly, comprising:
a support bearing and a mount, which are connected to one another by a support spring, and a working chamber and an equalization chamber, which are able to be filled with damping liquid and, at their sides facing axially towards one another, are spatially separated from one another by a separating wall and are connected to one another in a liquid-conducting manner by a damping channel included in the separating wall,
wherein the separating wall comprises a nozzle cage with first and second nozzle discs which are provided adjacent to one another with an axial spacing, wherein a diaphragm composed of a rubber-elastic material is provided in a gap formed by the axial spacing between the nozzle discs, and wherein the diaphragm is switchable by a switching device; and wherein the switching device comprises an elastic lever disc, which is provided axially adjacent to the second nozzle disc and able to act thereon, and an electromagnet, which is connected to the lever disc and can selectively adjust the lever disc between a first position, in which the lever disc permits axial play of the diaphragm in the gap, and a second position, in which the lever disc acts on the second nozzle disc and clamps the diaphragm between the nozzle discs.

2. The switchable hydraulic bearing according to claim 1, wherein the nozzle cage forms at least one point of rotation against which the lever disc, during adjustment between the first position and the second position, is supported in a lever-arm-forming manner.

3. The switchable hydraulic bearing according to claim 1, wherein the nozzle cage has a channel ring which is provided axially and/or radially adjacent to the second nozzle disc.

4. The switchable hydraulic bearing according to claim 3, wherein at least one lever tongue projects over the second nozzle disc in a radial direction.

5. The switchable hydraulic bearing according to claim 1, wherein the lever disc has a circumferentially outer pressing ring and/or multiple, radially running lever webs, each of which forms a lever arm.

6. The switchable hydraulic bearing according to claim 5, wherein a length ratio of resistance arm to force arm of the lever arm is between 1:10 and 1:2.

7. The switchable hydraulic bearing according to claim 1, wherein the lever disc has at least one retaining device which interacts with a retaining partner, wherein the retaining device is a retaining cutout or a retaining pin and the retaining partner is the respective other element of the retaining cutout and the retaining pin.

8. The switchable hydraulic bearing according to claim 1, wherein the second nozzle disc has a circumferential pressing edge which has a greater axial extent than the main body of the nozzle disc, and/or wherein, in its second position, the lever disc acts on the pressing edge.

9. The switchable hydraulic bearing according to claim 1, wherein the electromagnet is connected to the lever disc via a driver.

10. The switchable hydraulic bearing according to claim 1, wherein a spring element is arranged in the gap, said spring element being supported against the first and second nozzle discs and preloading the second nozzle disc into a gap-enlarging position.

11. The switchable hydraulic bearing according to claim 10, wherein the spring element comprises a clamping spring.

12. The switchable hydraulic bearing according to claim 10, wherein the spring element comprises a wave spring.

13. The switchable hydraulic bearing according to claim 3, wherein the ring channel has at least one radially running lever tongue on which the at least one point of rotation is formed.

14. The switchable hydraulic bearing according to claim 5, wherein the multiple, radially running lever webs comprise three radially running lever webs.

15. The switchable hydraulic bearing according to claim 6, wherein the length ratio of resistance arm to force arm of the lever arm is 1:6.

16. The switchable hydraulic bearing according to claim 9, wherein the electromagnet is connected in a floating manner to the lever disc via a driver.
